(19) United States
(12) Patent Application Publication
(10) Pub. No.: US 2008/0118889 A1
(43) Pub. Date: May 22, 2008

(54) Auxiliary cooling water supplier for a dental implant device

(76) Inventor: Wen-Hao Wang, Taipei City (TW)

Correspondence Address: BIRCH STEWART KOLASCH & BIRCH, PO BOX 747, FALLS CHURCH, VA, 22040-0747, US

(21) Appl. No.: 11/602,358

(22) Filed: Nov. 21, 2006

(51) Int. Cl. A61C 1/12; A61C 1/02

(52) U.S. Cl. 433/84; 433/82; 433/98

(57) ABSTRACT

The present invention discloses an auxiliary cooling water supplier for a dental implant device, which comprises a main machine having a built-in water-supply module, a conduit, an outlet module, a flowrate control circuit and a pedal. The main machine further comprises a control unit; the control unit is connected to the flowrate control circuit, and the flowrate control circuit is connected to the water-supply module. The user can use the control unit to regulate the flowrate of the outlet module or to switch between an automatic water-supply mode and a pedal control mode. The auxiliary cooling water supplier for a dental implant device of the present invention has the advantages of lightweight, portability, maneuverability, simple structure and easy operation.

### FIELD OF THE INVENTION

The present invention relates to an auxiliary cooling water supplier for a dental implant device, particularly to a machine, which sprays water to reduce the temperature of the bone of the dental-implant site and prevent the bone from being damaged by overheating.

### BACKGROUND OF THE INVENTION

The dental implant is more and more popular in prosthetic dentistry nowadays, and many dentists provide such a service. The two-stage dental implant is the most frequently adopted technology. It has been known that an artificial fang made of titanium can be perfectly integrated with the alveolar bone. In a dental implant surgical operation, a hole is bored in the alveolar bone, and a screw-like artificial fang is implanted in the hole. After a period of time, the bone will heal to integrate with the artificial fang. Then, an artificial tooth is joined to the artificial fang. Via the artificial fang, the biting force will be averagely distributed to the bone with no harm on the gum. Thus, the implanted artificial tooth can work just like a real one. During the dental implant surgical operation, the dentist will use the drill of a dental implant device to bore a hole on the alveolar bone of the patient. If the alveolar bone is overheated by the drilling action (e.g. the temperature of the alveolar bone is over 40□), the bone tissue will be damaged, and the rate of successful implants will be decreased. Therefore, the speed of the drill should not be too high, and cooling water (usually a saline solution) should be sprayed onto the drilled hole to lower the temperature of the bone. Generally, the dentist operates the dental implant device to drill a hole on the bone and controls the conventional cooling water supplier to provide the saline solution at the same time. To achieve the best cooling effect, cooling water should be sprayed from different angles, and the nurse must prepare several syringes containing saline solution to perform maneuverable cooling water spraying according to the instruction of the dentist. However, such an operation relies entirely on experience. Besides, manual operation is not as accurate as mechanical operation. Moreover, as the conventional cooling water supplier for a dental implant device is massive and hard to be moved to the desired position, it is usually necessary to invest more money in equipping the clinic with more than one set of cooling water supplier.

### SUMMARY OF THE INVENTION

One objective of the present invention is to provide an auxiliary cooling water supplier for a dental implant device, wherein the rate of cooling water supply can be timely and precisely controlled.

Another objective of the present invention is to provide an auxiliary cooling water supplier for a dental implant device, which has the advantages of lightweight, portability, maneuverability and easy operation.

According to a preferred embodiment, the auxiliary cooling water supplier for a dental implant device of the present invention comprises a main machine having a built-in water-supply module, a conduit, an outlet module, a flowrate control circuit. The main machine also has a control unit. The flowrate control circuit is connected to the water-supply module, and the user may use a rotation speed control knob to control the speed of water supply. The control unit is connected to the flowrate control circuit and controls the water-supply functions. One end of the conduit is connected to an external saline solution bottle, and the other end is connected to the outlet module. The water-supply module regulates the rate of the water supply flowing through the conduit.

### BRIEF DESCRIPTION OF THE DRAWINGS

FIG. 1 is a perspective view of a first preferred embodiment of the present invention.

FIG. 2 is a side view of a first preferred embodiment of the present invention.

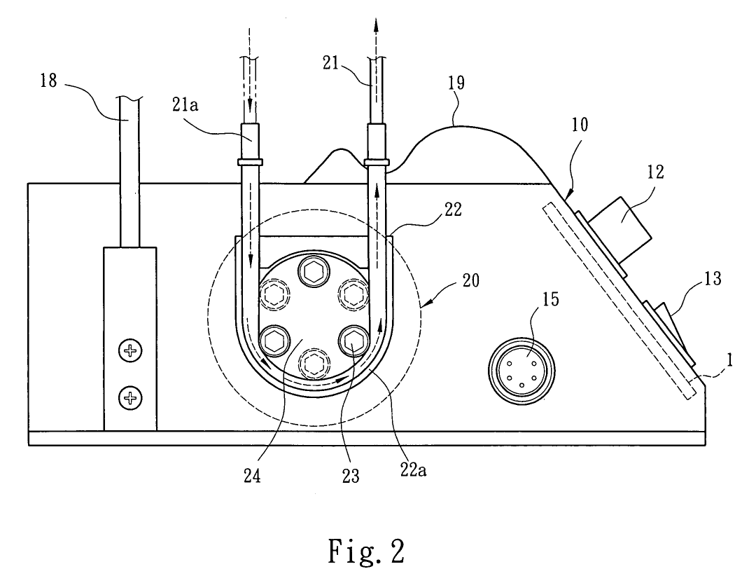

FIG. 3 is a block diagram of a first preferred embodiment of the present invention.

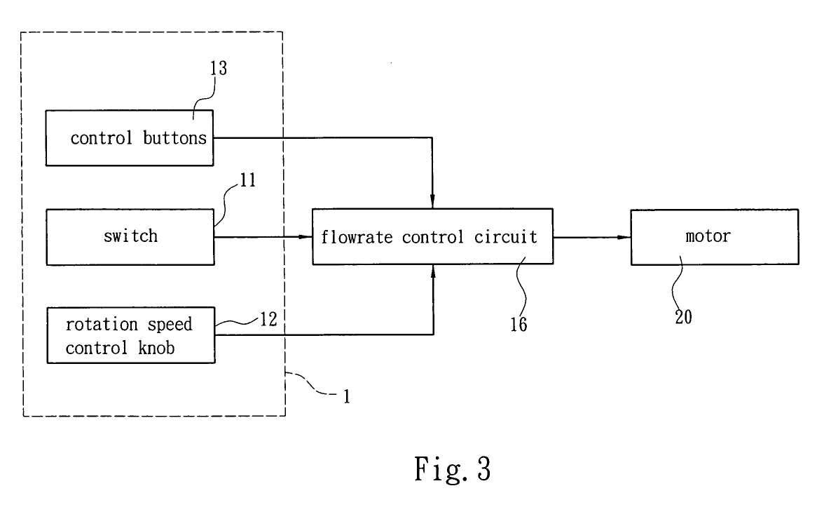

FIG. 4 is a block diagram of a second preferred embodiment of the present invention.

FIG. 5 is a perspective view of a second preferred embodiment of the present invention.

FIG. 6 is a perspective view of a third preferred embodiment of the present invention.

### DETAILED DESCRIPTION OF THE PREFERRED EMBODIMENTS

The technical contents of the present invention are to be described in detail in cooperation with the drawings below.

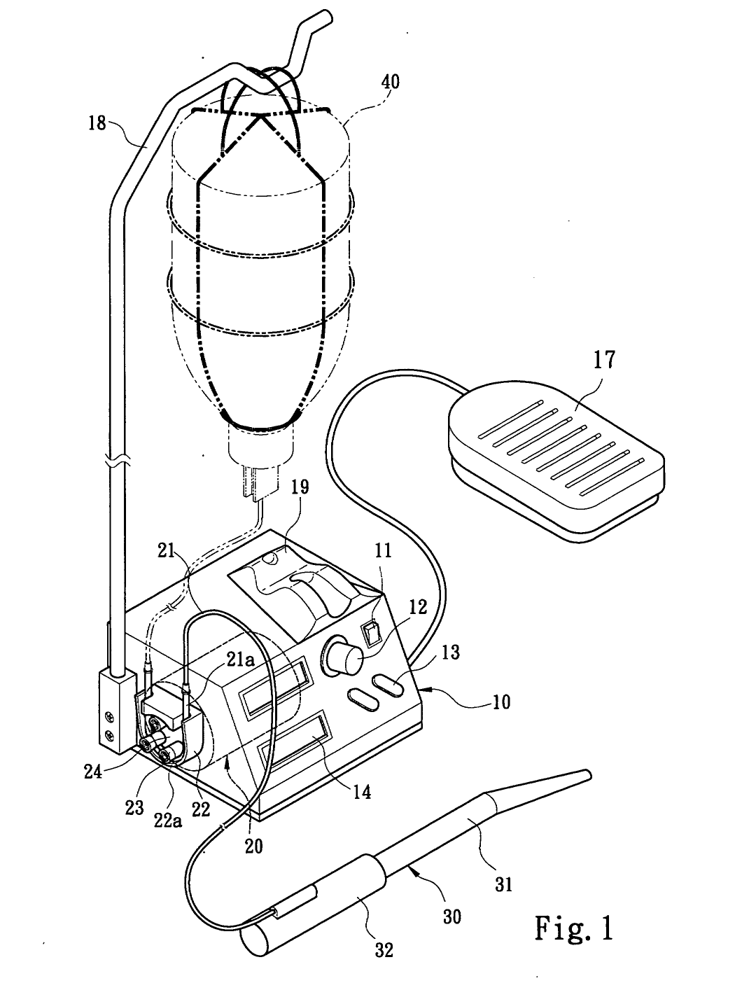

Refer to FIGS. 1˜3 respectively a perspective view, a side view and a block diagram of a first preferred embodiment of the present invention. In this embodiment, the auxiliary cooling water supplier for a dental implant device comprises a main machine 10 having a built-in water-supply module, a conduit 21, an outlet module 30, a pedal 17 and a flowrate control circuit 16. The main machine 10 further comprises a control unit (not shown in the drawings), and the control unit is connected to the flowrate control circuit 16 and controls the operation of the water-supply module. The control unit further comprises a switch 11, a rotation speed control knob 12 and a plurality of control buttons 13, and all of them are respectively connected to the flowrate control circuit 16. The water-supply module further comprises a motor 20, a driving disc 24, a plurality of rollers 23 and a supporter 22. The motor 20 is installed inside the main machine 10 and connected to the flowrate control circuit 16. Via the flowrate control circuit 16, the user can use the rotation speed control knob 12 to adjust the rotation speed of the motor 20 of the water-supply module and the flowrate of cooling water, wherein the motor 20 may be controlled with PWM (Pulse-Width-Modulation) signals or voltage signals. The plurality of control buttons 13 is connected to the flowrate control circuit 16 and used to switch between an automatic water-supply mode and a pedal-control mode. The pedal 17 is connected to the flowrate control circuit 16 from the exterior of the main machine 10. When the operation is switched to the pedal-control mode, the user can operate the pedal 17 to control the on/off of the electric power of the motor 20 via the flowrate control circuit 16. When the operation is switched to the automatic water-supply mode, the motor 20 rotates at a specified speed, and the water-supply rate is maintained constant. One end of the conduit 21 is connected to an external saline solution bottle 40, and the other end is connected to the outlet module 30. The water-supply module is used to squeeze the conduit 21 to supply cooling water. The supporter 22 is installed outside the main machine 10 and corresponding to the motor 20. The supporter 22 has an arc portion 22a. The driving disc 24 is installed in the inner side of the arc portion 22a and coupled to the transmission axle (not shown in the drawings) of the motor 20 and driven to rotate by the motor 20. The plurality of rollers 23 is averagely installed along the circumference of the driving disc 24. The conduit 21 has an enhanced section 21a; the enhanced section 21a is arranged between the rollers 23 and the arc portion 22a. The pressure of the rollers 23 makes the liquid inside the conduit 21 driven away from the outlet module 30.

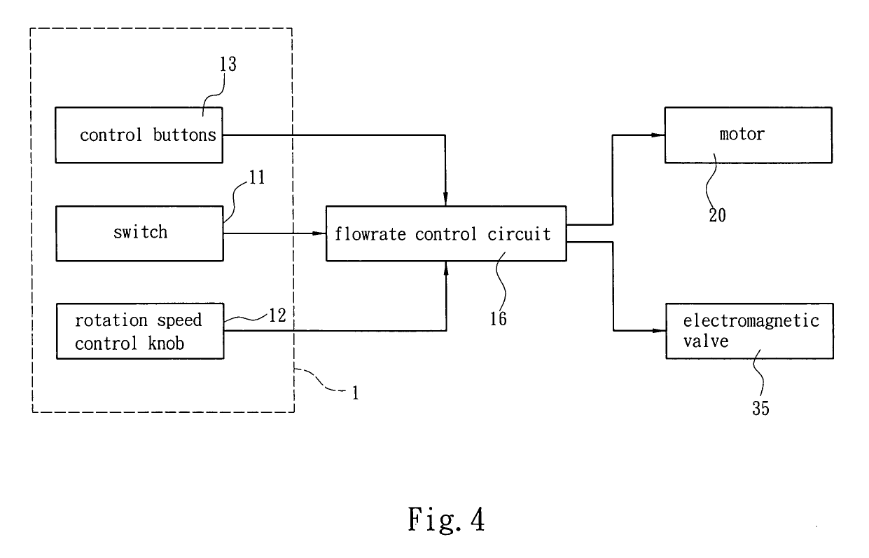

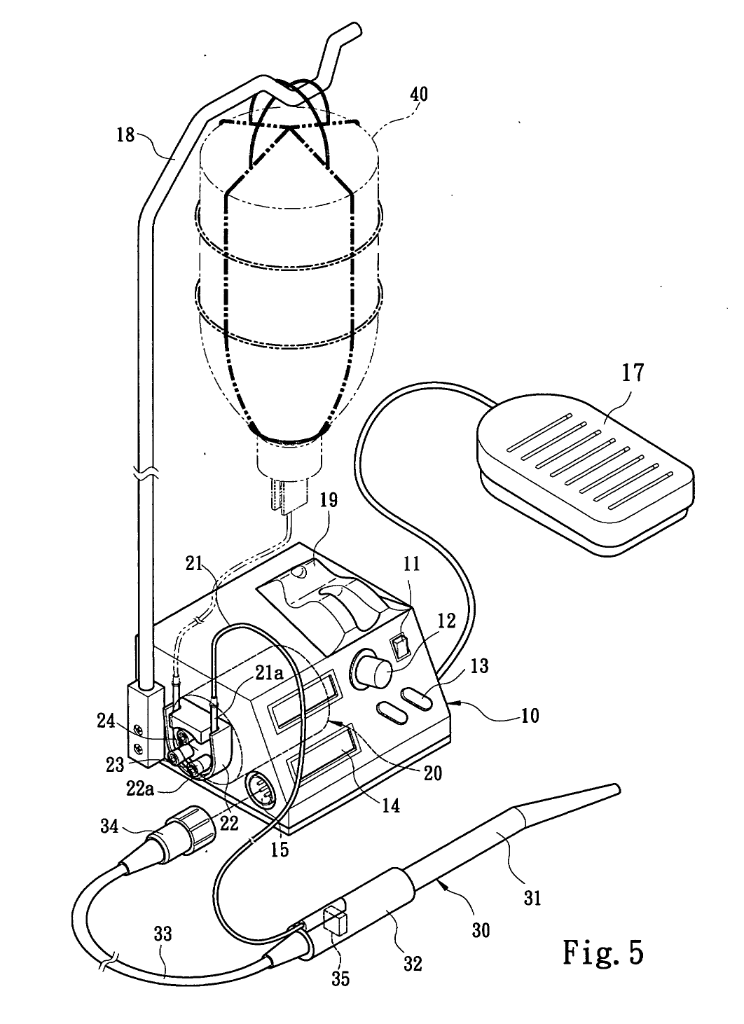

Refer to FIG. 4 and FIG. 5 a block diagram and a perspective view of a second preferred embodiment of the present invention. In this embodiment, the outlet module 30 further comprises a control cable 33, a first connector 34, a connection section 32, an outlet section 31 and an electromagnetic valve 35. The connection section 32 connects the conduit 21 the outlet section 31. The electromagnetic valve 35 is installed in the connection section 32 and between the conduit 21 and the outlet section 31. The main machine 10 has a second connector 15 able to connect with the first connector 34. The flowrate control circuit 16 is connected to the electromagnetic valve 35 via the control cable 33 and controls the electromagnetic valve 35 to open or close water supply.

In the preferred embodiments of the auxiliary cooling water supplier for a dental implant device of the present invention, a display unit 14 may be installed in the main machine 10 and exposed to the exterior and connected to the flowrate control circuit 16 and used to present the on/off state of the electric power and the operational mode.

In the preferred embodiments of the auxiliary cooling water supplier for a dental implant device of the present invention, a crutch 18 may be installed on the surface of the main machine 10 and used to carry the saline solution bottle 40.

In the preferred embodiments of the auxiliary cooling water supplier for a dental implant device of the present invention, an accommodation seat 19 may be installed on the main machine 10 and used to accommodate the outlet module 30.

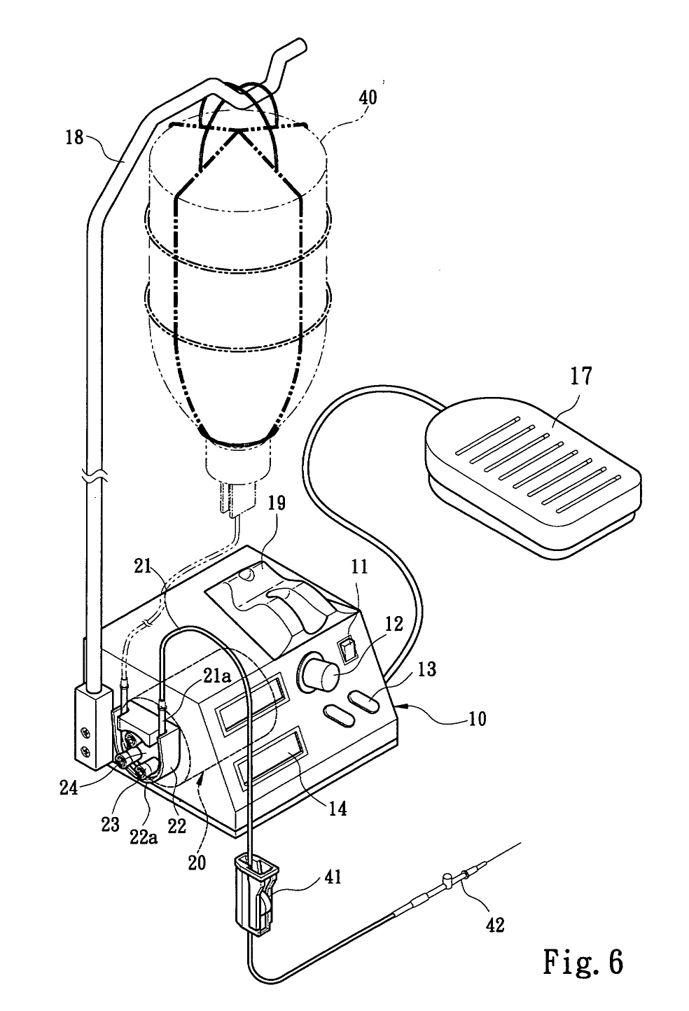

Refer to FIG. 6 a perspective view of a third preferred embodiment of the present invention. In this embodiment, the outlet module 30 is an injector 42 directly installed at the end of the conduit 21, and the injector 42 can provide a converged beam of water. A manual regulator 41 may also be installed between the conduit 21 and the outlet module 30 for controlling the flowrate of water.

The described above are the preferred embodiments to exemplify the present invention. However, it is not intended to limit the scope of the present invention. Any equivalent modification and variation according to the spirit of the present invention is to be also included within the scope of the present invention.

1. An auxiliary cooling water supplier for a dental implant device, which obtains water from a saline solution bottle to cool down the alveolar bone during a dental implant process, comprising:
a main machine, further comprising a conduit, an outlet module, wherein one end of said conduit is connected to said saline solution bottle, and the other end is connected to said outlet module;
a water-supply module, installed in said main machine and used to squeeze said conduit to supply cooling water;
a flowrate control circuit, connected to said water-supply module and controlling the operation of said water-supply module;
a switch, connected to said flowrate control circuit and used to control a power source; and
a control unit, connected to said flowrate control circuit and used to control the operation of said water-supply module;
wherein said water-supply module further comprises
a motor,
a driving disc,
a plurality of rollers, and
a supporter,
wherein said supporter is installed outside said main machine and corresponding to said motor,
wherein said supporter has an arc portion,
wherein said driving disc is installed in the inner side of said arc portion and coupled to a transmission axle of said motor and driven to rotate by said motor, and
wherein the plurality of said rollers is averagely installed along the circumference of said driving disc.

2. (canceled)

3. The auxiliary cooling water supplier for the dental implant device according to claim 1, wherein a portion of said conduit is disposed along said path; said water-supply module rotates to squeeze said conduit to supply cooling water.

4. The auxiliary cooling water supplier for the dental implant device according to claim 1, wherein said control unit further comprises a rotation speed control knob, and said rotation speed control knob is connected to said flowrate control circuit and used to control the operational speed of said water-supply module.

5. The auxiliary cooling water supplier for the dental implant device according to claim 1, wherein said control unit further comprises a plurality of control buttons and a pedal; said pedal is connected to said main machine; said control buttons are installed in said main machine and exposed to the exterior and connected to said flowrate control circuit and used to switch between a pedal-control mode and an automatic water-supply mode.

6. The auxiliary cooling water supplier for the dental implant device according to claim 1, wherein said outlet module further comprises a control cable, a first connector, a connection section, an outlet section and an electromagnetic valve; said connection section connects said conduit and said outlet section; said electromagnetic valve is installed in said connection section and between said conduit and said outlet section; said main machine has a second connector able to connect with said first connector; said flowrate control circuit is connected to said electromagnetic valve via said control cable and controls said electromagnetic valve to open or close water supply.

7. The auxiliary cooling water supplier for the dental implant device according to claim 1, wherein a display unit is installed in said main machine and exposed to the exterior and connected to said flowrate control circuit and used to present the on/off state of the electric power and the operational mode.

8. The auxiliary cooling water supplier for the dental implant device according to claim 1, wherein said outlet module is an injector directly installed at the end of said conduit, and said injector provides a converged beam of water.

9. The auxiliary cooling water supplier for the dental implant device according to claim 1, wherein a manual regulator is installed between said conduit and said outlet module to control the flowrate of water.
